(19) United States
(12) Patent Application Publication
(10) Pub. No.: US 2018/0266140 A1
(43) Pub. Date: Sep. 20, 2018

(54) POWER GENERATING BARRIER WALL

(71) Applicant: Franklin Lynnwood Farr, Lake Havasu City, AZ (US)

(72) Inventor: Franklin Lynnwood Farr, Lake Havasu City, AZ (US)

(21) Appl. No.: 15/917,456

(22) Filed: Mar. 9, 2018

Related U.S. Application Data
(60) Provisional application No. 62/469,985, filed on Mar. 10, 2017.

(51) Int. Cl. E04H 17/14; H02S 20/32; H02S 30/10; H02S 40/34; E04B 2/02; E04B 2/84; E04B 2/58; E02D 27/32

(52) U.S. Cl. CPC E04H 17/1417; H02S 20/32; H02S 30/10; H02S 40/34; E04B 2/02; E04B 2103/06; E04B 2/58; E04H 17/1404; E02D 27/32; E04B 2103/02; E04B 2/84

(57) ABSTRACT

A barrier wall including a plurality of sections positioned in immediate juxtaposition to each other to form a substantially continuous barrier wall. Each section includes a foundation below ground level, a base wall carried by the foundation, a framework carried by the base wall, and a plurality of solar panel assemblies movably carried by the framework.

### CROSS-REFERENCE TO RELATED APPLICATIONS

This application claims the benefit of U.S. Provisional Patent Application No. 62/469,985, filed 10 Mar. 2017.

### FIELD OF THE INVENTION

This invention relates to barrier walls and more particularly, to barrier walls having power generating capabilities.

### BACKGROUND OF THE INVENTION

Barrier wall in the context of this disclosure is defined as a structure designed and built to bar passage through or across a boundary or demarcation line. Barrier walls can be used in many situations to prevent access by unauthorized personnel to areas beyond the barrier wall. As an example, the barrier wall of this invention would be ideal for use as a border wall to prevent unauthorized migration across a border. Barrier walls can also be used to encircle installations and the like as well as many other applications.

In the prior art, barriers constructed to prevent passage have been difficult to maintain because they generally require some periodic surveillance which greatly increases the cost and opportunities for failure to bar passage.

It would be highly advantageous, therefore, to remedy this and other deficiencies inherent in the prior art.

Accordingly, it is an object of the present invention to provide a new and improved barrier wall.

It is another object of the present invention to provide a new and improved barrier wall having power generating capabilities.

It is another object of the present invention to provide a new and improved barrier wall having power generating capabilities that can render the structure virtually self-sustainable.

### SUMMARY OF THE INVENTION

The desired objects of the instant invention are achieved in accordance with the provision of a barrier wall including a plurality of sections positioned in immediate juxtaposition to each other to form a substantially continuous barrier wall. Each section includes a foundation below ground level, a base wall carried by the foundation, a framework carried by the base wall, and a plurality of solar panel assemblies movably carried by the framework.

The desired objects of the instant invention are also achieved in accordance with a specific embodiment of a barrier wall including a plurality of sections. Each section includes a concrete foundation, a base wall, a framework, and a plurality of solar panel assemblies. The concrete foundation is below ground level a depth sufficient to firmly support the remaining components of the barrier wall section that includes the foundation. The base wall is carried by the foundation and is one of fixedly attached to the foundation and an integral part of the foundation. The framework is carried by the base wall and includes upright members fixed by the base wall and extending upwardly from the base wall and cross-pieces fixed to the upright members, the framework having opposing sides. The plurality of solar panel assemblies is movably carried by the framework. The plurality of solar panel assemblies includes two solar panel assemblies, one each affixed to each of the opposing sides of the framework and each solar panel assembly includes a panel frame including a top edge hingedly coupled to an upper cross piece of the framework. The solar panel assemblies each are movable between an extended position and a retracted position, in the retracted position each solar panel assembly lies flat against the framework and acts as a barrier and in the extended position each solar panel assembly is pivotable about the hinged top edge away from the framework to an open angle of up to 45 degrees.

### BRIEF DESCRIPTION OF THE DRAWINGS

Specific objects and advantages of the invention will become readily apparent to those skilled in the art from the following detailed description of a preferred embodiment thereof, taken in conjunction with the drawings in which:

FIG. 1 is a perspective view of an expanse of barrier wall according to the present invention;

FIG. 2 is a perspective view of a section of barrier wall according to the present invention;

FIG. 3 is a front view of a frame portion of the section of barrier wall of FIG. 2;

FIG. 4 is a front view of the barrier wall of FIG. 2; and

FIG. 5 is an end view of the section of barrier wall of FIG. 2.

### DETAILED DESCRIPTION OF A PREFERRED EMBODIMENT

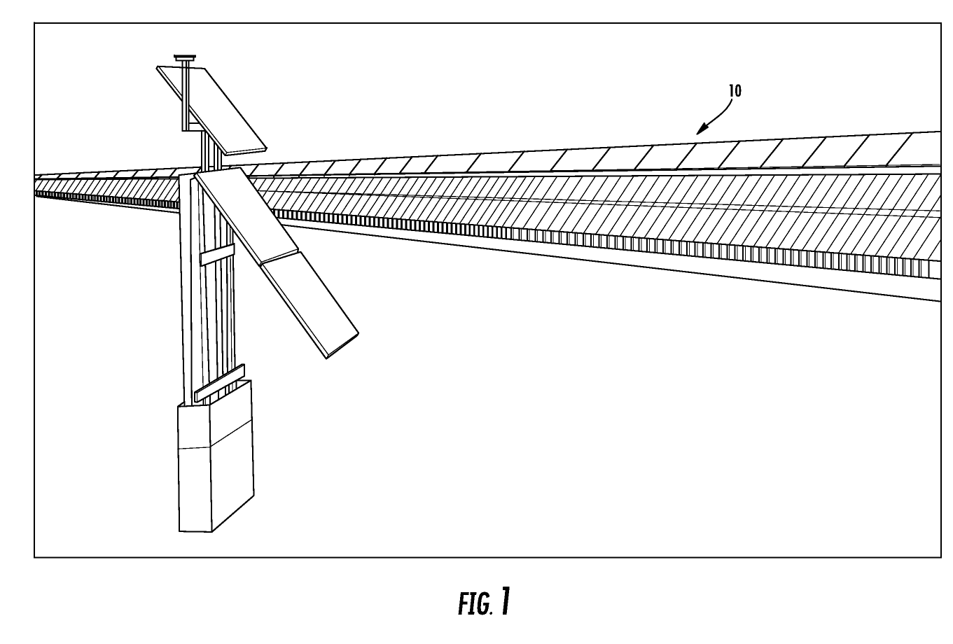

Turning now to the drawings in which like reference characters indicate corresponding elements throughout the several views, attention is directed to FIG. 1 which illustrates a barrier wall generally designated 10. Barrier wall 10 can be used in many situations to prevent access by unauthorized personnel to areas beyond the barrier wall. As an example, barrier wall 10 would be ideal for use as a border wall to prevent unauthorized migration across a border. Barrier wall 10 can also be used to encircle installations and the like as well as many other applications. Barrier wall 10 includes solar panels containing photovoltaic cells to generate power as well as acting as a barrier component. The large number of solar panels can generate energy to power supplemental accessories such as cameras, lights, sensors and other surveillance equipment, which can make barrier wall 10 virtually self-sustainable.

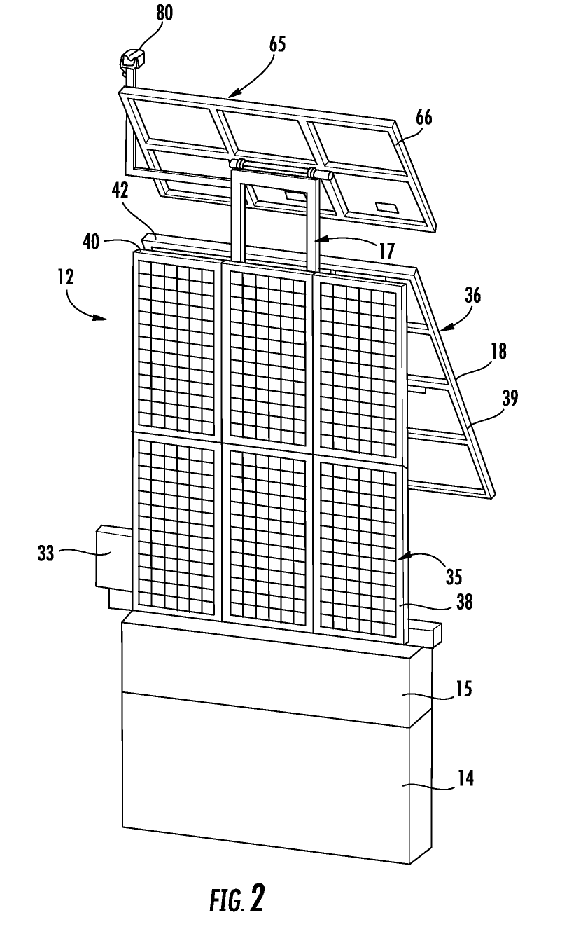

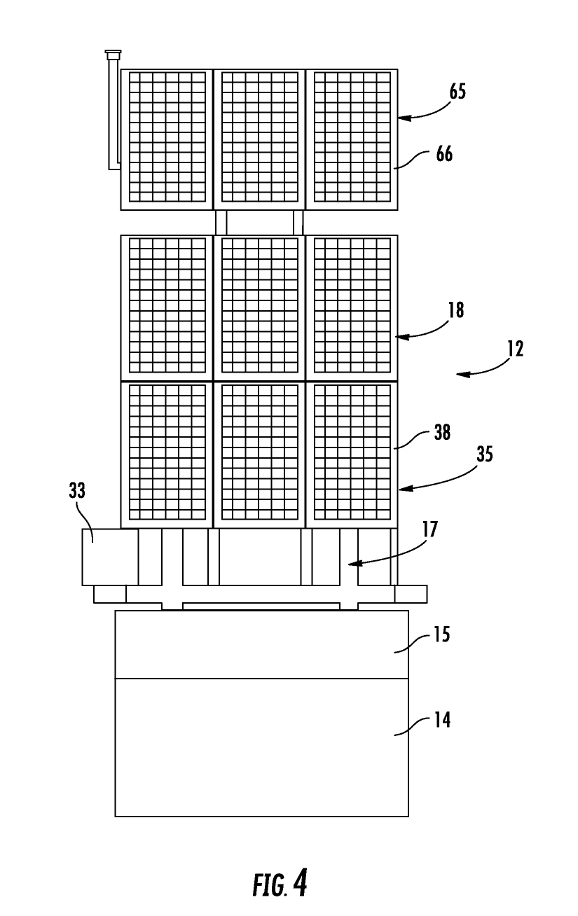

Turning now to FIGS. 2-4, barrier wall 10 includes a plurality of sections 12 positioned in immediate juxtaposition to each other to form the substantially continuous barrier wall 10. Each section 12 includes a foundation 14 below ground level, a base wall 15 carried by the foundation, a framework 17 carried by the base wall 15, and a plurality of solar panel assemblies movably carried by framework 17. Foundation 14 is preferably constructed of concrete and has a depth sufficient to firmly support the remaining components of barrier wall 10. It will be understood by those of ordinary skill in the art that the extent or parameters of the term “sufficient to firmly support the remaining components” are clearly dictated by good construction engineering, which includes determining the effects of height, weight, sheer forces (e.g. wind, etc.) all of which are well-known in the engineering community. In the preferred embodiment, foundation 14 is 60 inches in height, 24 inches wide, and 120 inches in length. Base wall 15 can be fabricated of materials such as concrete, stone brick and the like, and is intended to rise above ground level to provide a supporting base and allow clearance from the ground for the remaining components of barrier wall 10. It will be understood that base wall 15 could be an extension or continuation of foundation 14 (e.g. both formed of concrete) and is preferably fixedly attached to or an integral part of foundation 14. In the preferred embodiment, base wall 15 is 30 inches in height but may be extended as high as desired.

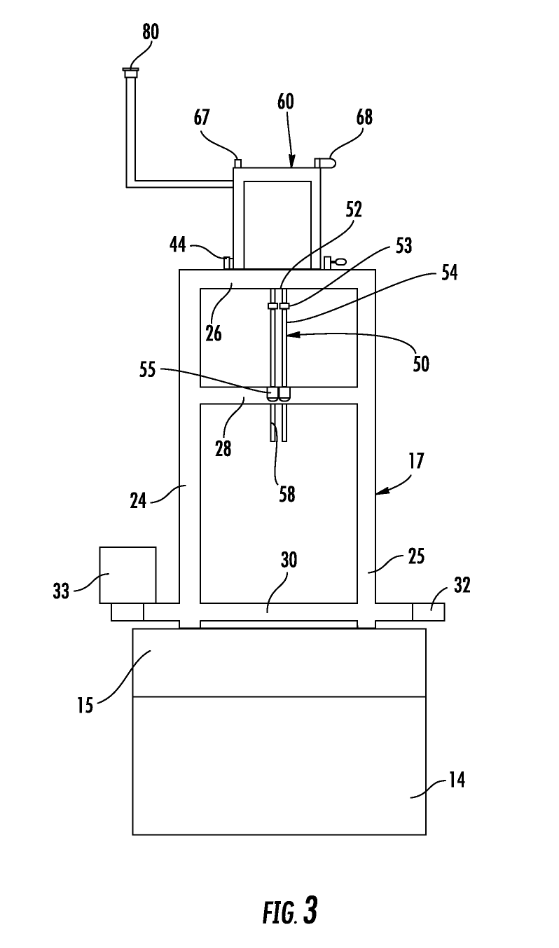

Referring specifically to FIG. 3, framework 17 is a strong rigid structure preferably formed of steel tubular members. Framework 17 is securely attached to base wall 15 and is held in a rigidly upright position. One of ordinary skill will understand that framework 17 can take many forms, but does have opposing sides 20 and 22. Preferably, upright members 24 and 25 extend upwardly from base wall 15 and are spaced apart. An upper cross piece 26, an intermediate cross piece 28 and a lower cross piece 30 extend between upright members 24 and 25, and provide rigidity and strength to framework 17. Upper cross piece 26 and intermediate cross piece 28 also provide a base upon which a panel actuation assembly 50 is mounted. Lower cross piece 30 extends beyond upright members 24 and 25, and is joined to adjacent lower cross pieces 30 of adjacent sections 12 by wire-way couplers 32. In this manner, wiring for collecting and transmitting power from the solar panels, as well as wiring for accessories such as communications devices, cameras and lighting, can be run through lower cross pieces 30. Electrical boxes 33 can be carried by framework 17 between the solar panels

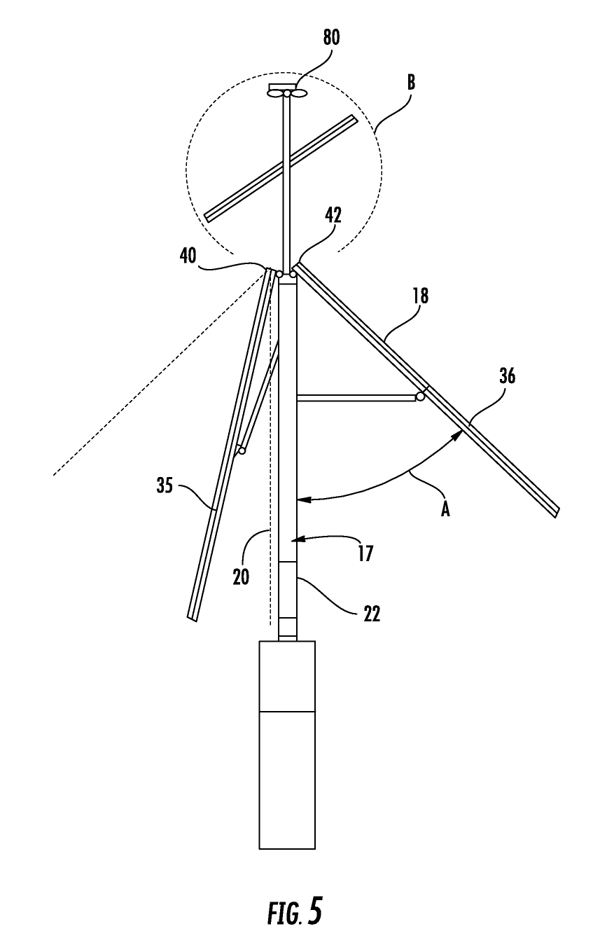

Referring to FIGS. 2, 4 and 5, each section 12 of barrier wall 10 includes a solar panel assembly 35 carried by side 20 of framework 17 and a solar panel assembly 36 carried by side 22 of framework 17. In the preferred embodiment described herein, each solar panel assembly is formed of six solar panels. While six conventional solar panels are used herein, it will be understood that more or less can be employed as desired, to cover a wider/narrower, or taller/shorter section. In this embodiment, the solar panel assemblies 35, 36 each include a panel frame 38, 39, respectively, that is 120 inches by 156 inches to carry and support the six solar panels. Other dimensions can be used as desired. Panel frames 38, 39 include a top edge 40, 42, respectively, which are each hingedly coupled to a top surface of upper cross piece 26 using, for example, pillow blocks 44. Solar panel assemblies 35 and 36 are each movable between an extended position and a retracted position. In the retracted position, each assembly lies generally flat against frame work 17 and acts as a barrier. In the extended position, each assembly can be pivoted about hinged top edge 40, 42, with the bottom end swinging away from framework 17 to a fully open angle of 45 degrees as shown by arrowed line A. In this manner, depending on the placement of the sun in the sky, the panel assemblies can be extended to capture maximum sunlight. To ensure that barrier wall 10 remains a barrier at all times, only one of panel assemblies 35 and 36 can be extended at any time. Thus, the panel assembly on one side can be extended to capture maximum sunlight, while the panel on the opposing side of framework 17 remains in the retracted position to act as a barrier.

Referring back to FIG. 3, panel assemblies 35 and 36 are each pivoted by panel actuation assembly 50. In the preferred embodiment, a screw support guide 52 is mounted on upper cross piece 26, a drive nut 53 and lead screw 54 are driven by a servo motor 55 moving solar panel assembly 38 with an angle adjust arm 58 between the extended and the retracted position. A similar arrangement is used for panel assembly 39.

An additional level can be added to barrier wall 10 by inclusion of supplemental frame 60 extending upwardly from upper cross piece 26 of framework 17. A single solar panel assembly 65 is pivotally coupled to supplemental framework 60 and rotated thereabout in a full 360 degree arc, as shown by dotted line B, by a servo motor 68. Thus, the top panel can always be oriented toward the sun. Panel 65 is preferably the full width of section 12, including a frame 66 carrying three solar panels. Additional sensors, lights, cameras 80 and the like can be mounted adjacent solar panel assembly 65, carried by supplemental framework 60. These various accessories would not necessarily be present on each section 12, but spaced as desired.

In this structure, a barrier wall is provided which includes solar panels to produce electrical energy which can be used to operate the motors to direct the solar panel assemblies, various associated sensors, lights, cameras, and the like, and/or stored for later use (e.g. batteries, etc.). In use as a border barrier wall, surveillance command stations will preferably be centered on each three mile section of wall. The stations will be manned 24 hours a day to ensure any suspected activity is immediately reported to appropriate personnel. The command stations will also insure that the solar panels are maintained and operable. Access gates can be built into barrier wall 10 to permit access to solar panels on both sides of the wall. This may require a setback from a border. The generated electricity and/or stored electricity can be used to power various associated sensors, lights and the like as well as any command or observation buildings. Surplus energy can be delivered to nearby communities or coupled directly to a municipal electric grid and the like.

Thus, a barrier wall has been disclosed that is fully capable of preventing access to a designated area and which provides generation of electricity sufficient to support periodic or constant surveillance by or through the use of sensors, cameras, communications devices, etc. Because the electric generation is sun powered, the barrier wall is not only virtually self-sustaining but may actually produce excess electrical power that can be used for other purposes.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A barrier wall comprising:
a plurality of sections, each section including:
a foundation;
a base wall carried by the foundation,
a framework carried by the base wall; and
a plurality of solar panel assemblies movably carried by the framework.

2. The barrier wall as claimed in claim 1 wherein the plurality of sections is positioned in immediate juxtaposition to each other to form a substantially continuous barrier wall.

3. The barrier wall as claimed in claim 1 wherein the foundation is below ground level.

4. The barrier wall as claimed in claim 1 wherein the foundation has a depth sufficient to firmly support the remaining components of the barrier wall section that includes the foundation.

5. The barrier wall as claimed in claim 1 wherein the foundation includes concrete.

6. The barrier wall as claimed in claim 1 wherein the base wall is one of fixedly attached to the foundation and an integral part of the foundation.

7. The barrier wall as claimed in claim 1 wherein the framework includes steel tubular members securely attached to the base wall held in a rigidly upright position.

8. The barrier wall as claimed in claim 7 wherein the framework includes upright members fixed by the base wall and extending upwardly from the base wall and cross-pieces fixed to the upright members, the framework having opposing sides.

9. The barrier wall as claimed in claim 8 wherein the plurality of solar panel assemblies includes two solar panel assemblies, one each affixed to each of the opposing sides of the framework.

10. The barrier wall as claimed in claim 8 wherein the framework includes a lower cross-piece with lower cross-pieces of adjacent sections joined by wire-way couplers.

11. The barrier wall as claimed in claim 10 wherein the lower cross-piece includes wiring for collecting and transmitting power from the plurality of solar panel assemblies, as well as wiring for accessories.

12. The barrier wall as claimed in claim 9 wherein the solar panel assemblies each include a panel frame, the panel frame including a top edge hingedly coupled to an upper cross piece of the framework.

13. The barrier wall as claimed in claim 12 wherein the solar panel assemblies are each movable between an extended position and a retracted position, in the retracted position each solar panel assembly lies flat against the framework and acts as a barrier and in the extended position each solar panel assembly is pivotable about the hinged top edge away from the framework to an open angle of up to 45 degrees.

14. The barrier wall as claimed in claim 13 further including at least one panel actuation assembly attached to the framework and each solar panel assembly.

15. The barrier wall as claimed in claim 13 wherein the panel actuation assembly including a screw support guide mounted on the upper cross piece, a drive nut and lead screw, the lead screw being driven by a servo motor for moving the solar panel assembly between the extended position and the retracted position.

16. The barrier wall as claimed in claim 12 wherein the solar panel assemblies are coupled so that when one solar panel assembly is in an extended position the other solar panel assembly is in a retracted position.

17. The barrier wall as claimed in claim 8 wherein the framework includes a supplemental frame extending upwardly from an upper cross piece of the framework and rotatable through a 360 degree arc, the supplemental frame having a solar panel assembly pivotally coupled thereto.

18. A barrier wall comprising:
a plurality of sections, each section including:
a concrete foundation below ground level a depth sufficient to firmly support the remaining components of the barrier wall section that includes the foundation;
a base wall carried by the foundation, the base wall being one of fixedly attached to the foundation and an integral part of the foundation;
a framework carried by the base wall, the framework including upright members fixed by the base wall and extending upwardly from the base wall and cross-pieces fixed to the upright members, the framework having opposing sides;
a plurality of solar panel assemblies movably carried by the framework, the plurality of solar panel assemblies including two solar panel assemblies, one each affixed to each of the opposing sides of the framework and each solar panel assembly including a panel frame including a top edge hingedly coupled to an upper cross piece of the framework; and
the solar panel assemblies each being movable between an extended position and a retracted position, in the retracted position each solar panel assembly lies flat against the framework and acts as a barrier and in the extended position each solar panel assembly is pivotable about the hinged top edge away from the framework to an open angle of up to 45 degrees.

19. The barrier wall as claimed in claim 18 wherein the cross-pieces include a lower cross-piece, the lower cross-piece of each section joined by wire-way couplers with lower cross-pieces of adjacent sections, and the lower cross-piece of each section including wiring for collecting and transmitting power from the plurality of solar panel assemblies, as well as wiring for accessories.

20. The barrier wall as claimed in claim 18 wherein the cross-pieces include an upper cross-piece, the framework further including a supplemental frame extending upwardly from the upper cross piece of the framework and rotatable through a 360 degree arc, the supplemental frame having a solar panel assembly pivotally coupled thereto.

21. The barrier wall as claimed in claim 18 further including at least one panel actuation assembly attached to the framework and each solar panel assembly, the panel actuation assembly including a screw support guide mounted on the upper cross piece, a drive nut and lead screw, the lead screw being driven by a servo motor for moving the solar panel assembly between the extended position and the retracted position.
